(19) United States
(12) Patent Application Publication
(10) Pub. No.: US 2007/0131145 A1
(43) Pub. Date: Jun. 14, 2007

(54) Multi-function composition for settable composite materials and methods of making the composition

(76) Inventors: Giang Biscan, Fontana, CA (US); Hamid Hojaji, Claremont, CA (US); Basil Naji, Toongabbie (AU); Padmaja Parakala, Wentworthville (AU)

Correspondence Address: GARDERE / JAMES HARDIE;GARDERE WYNNE SEWELL, LLP, 1601 ELM STREET, SUITE 3000, DALLAS, TX, 75201, US

(21) Appl. No.: 11/299,330

(22) Filed: Dec. 9, 2005

(51) Int. Cl. C04B 28/26; C04B 40/00

(52) U.S. Cl. 106/600; 106/606; 106/632; 106/819

(57) ABSTRACT

A multi-function composition for incorporation into settable composite materials is provided. The composition is formulated as an additive to modify the density of the composite material and increase the rate of hardening or strength development of the material. The composition of the additive generally includes an alkaline activation compound such as sodium silicate and a modified low density siliceous material having at least one region morphologically altered by a chemical, such as a partially digested region. The additive can be in slurry form, in powder form, or in an agglomerated particle form. The additive can be produced using a two-stage process in which a siliceous material is reduced in particle size, combined with an alkali compound in a solution and then digested in an atmospheric or pressurized vessel. In some implementations, the solution can be spray dried to form agglomerated particles containing the alkaline activation compound and the low density siliceous particle having one or more partially digested regions.

### BACKGROUND OF THE INVENTION

1. Field of the Invention

This invention generally relates to compositions for incorporation into settable composite materials, and in particular, relates to a composition that performs multiple functions including modifying the density of the composite material and increasing the rate of strength development of the material. This invention also relates to methods of making the composition and the composite materials incorporating the composition.

2. Description of the Related Art

It has long been desired to be able to increase the rate of strength development or hardening in settable composite materials such as those made with ordinary Portland cement. Rapid strength development is especially desirable in applications related to the manufacture of lightweight building materials such as foamed building blocks and low density fiber-reinforced cement cladding sheets. To this end, a number of approaches have been developed to accelerate the rate of hardening or strength development in cement-based building products. These approaches include thermal acceleration by utilizing steam or hydrothermal curing and chemical acceleration by adding accelerators and hardening promoters. However, these conventional approaches are quite costly due to the need for large capital investment in equipment and raw material. For example, thermal acceleration processes typically require setting up steam curing chambers and autoclaves. Chemical acceleration processes typically involve the use of expensive additives.

In addition to rapid strength development, it is also desirable to lower the density of certain cementitious materials. In particular, density-modifying fillers are widely used in lightweight building materials. One such filler is commercially available synthetic low density calcium silicate hydrate, such as those sold under the name of Celite Micro-cel A or E by World Minerals in Lompoc, California. While calcium silicate hydrate is commonly used as a density modifier in fiber-reinforced composite materials, it is costly to manufacture because of the requirement of high temperature and high pressure digestion processes. The high manufacturing cost makes the material a high cost component in lightweight fiber-reinforced products.

It is therefore an object of the present invention to overcome or ameliorate at least one of the disadvantages of the prior art, or to provide a useful alternative. In one embodiment, it would be a significant advance in the art to produce a low cost composition such as an additive having the combined properties of a hardening accelerator and a low density filler.

### SUMMARY OF THE INVENTION

As used herein, the term “alkaline activation compound” is a broad term and shall have its ordinary meaning and shall include, but not be limited to, an alkaline compound that is capable of reacting with aluminosilicate, preferably forming cross-linking compounds. The aluminosilicate can be an existing component of the composite material and/or can be added to the composite material composition.

The term “aluminosilicate material” is a broad term and shall have its ordinary meaning and shall include, but not be limited to, a reactive siliceous material with an Al₂O₃ content of greater than or equal to about 10%, preferably greater than about 20%, more preferably greater than about 30%.

The term “siliceous material” or “siliceous particles” is a broad term and shall have its ordinary meaning and shall include, but not be limited to, a material containing predominantly silica and/or silicate. The material can be in any shape or form including solid, hollow, fibrous, spherical, or partially round particles, agglomerates or aggregates.

The term “altered by a chemical” is a broad term and shall have its ordinary meaning and shall include, but not be limited to, changes in physical and/or chemical properties of a material caused by a chemical. The change may manifest in such morphological appearances as rough, edgy, spiky, sponge-like, coral-like, porous and/or gel-like state that occurs when a substantially solid material is leached, reacted, decomposed, partially digested, broken down or otherwise changed by a chemical compound. Alternatively, the change may manifest in a chemical properties or composition alteration, for example showing a substance or compound, being substantially richer or leaner in one region than the rest of the material, due to differential or preferential reaction, leaching, digestion, and so on. Changes in both, morphological or chemical, may also be presented together.

The term “modified siliceous particle” is a broad term and shall have its ordinary meaning and shall include, but not be limited to, a siliceous particle that is partially altered by a chemical such that the modified particle has one or more regions that are morphologically altered by the chemical.

The term “low density” is a broad term and shall have its ordinary meaning and shall include, but not be limited to, a bulk density of about 1,500 kg/m³ or less.

In one aspect, the preferred embodiments of the present invention provide a multi-function additive composition for a settable composite material. The composition comprises an alkaline activation compound and a plurality of modified siliceous particles or aggregates, wherein each modified siliceous particle has a first region that is morphologically altered by a chemical. Each of the modified siliceous particle also has a second region that is not morphologically altered by the chemical. Preferably, the first region comprises about 0.1% to 95% of the volume of the particle, more preferably about 0.5% to 80%, more preferably about 2% to 50%, and more preferably 4% to 30%. In one embodiment, the first region of the modified siliceous particle is gel-like, porous, spiky or edgy. In another embodiment, the first region comprises a part of the exterior surface of the particle and the second region comprises primarily a core of the particle. In other embodiment, the first region is also chemically altered by the chemical. The alkaline activation compound is preferably selected from the group consisting of alkali silicate and silica enriched alkali silicate, such as sodium silicate, potassium silicate, and lithium silicate or combination thereof. In certain implementations, the composition can be incorporated in a cementitious formulation, a fiber cement building product, gypsum composite or a polymeric matrix. In some embodiments, the additive composition preferably enables acceleration in setting and hardening of the settable composite material. In other embodiments, the additive enables hardening of the settable composite material in non-elevated temperature and/or pressure conditions.

In another aspect, the preferred embodiments of the present invention provide a multi-function additive composition for a settable composite material. The composition comprises an alkaline activation compound and a plurality of siliceous particles, in some embodiments including siliceous aggregates, wherein each particle has at least one region that is altered by a chemical. Preferably, the at least one region altered by a chemical is greater than 0.1% of the volume of the particle, more preferably comprises about 0.1%-95% of the volume of the particle. In one implementation, the at least one region altered by a chemical is altered by an alkali compound. The at least one region altered by a chemical is preferably substantially gel-like, spiky, rough, edgy and/or porous. Preferably, each particle also has at least one region that is not altered by a chemical wherein the at least one region not altered by a chemical comprising about 0.1%-90% of the volume of the particle. In one embodiment, the siliceous particles have a mean particle diameter of less than about 10 μm. In certain preferred embodiments, the alkaline activation compound comprises an alkali silicate, a silica enriched alkali silicate, such as one that is selected from the group consisting of sodium silicate, potassium silicate, lithium silicate or combination thereof. In one implementation, the alkaline activation compound consists essentially of sodium silicate. The siliceous particles preferably originate from a source material selected from the group consisting of feldspar, basalt rock, red mud, tuff, volcanic ash, obsidian, diatomaceous earth, reactive clay, waste glass, slag, cement kiln dust, fly ash, bottom ash, incinerator ash, coal beneficiation rejects, silica fume, silica dust, rice hull ash, silica, silicate, clay, glass, pulverized rocks, and combinations thereof. The composition of one embodiment can be incorporated in a cement formulation, a fiber cement building product, or a polymeric matrix. The settable composite material is preferably selected from the group consisting of aluminosilicate material, cement, concrete, fiber cement, gypsum, polymer, and combinations thereof. The additive composition preferably enables the settable composite material to set and harden without the need of being subjected to a hydrothermal curing condition. In the preferred embodiments, setting generally refers to when the material achieves a state where it can be handled without being significantly deformed and hardening generally refers to the process by which a material achieves significant strength.

In one embodiment, the multi-fiction additive composition is in a slurry form, wherein the slurry comprises the alkaline activation compound and the siliceous particles having at least one region altered by a chemical. The alkaline activation compound is substantially dissolved in the liquid phase and the siliceous particles having at least one region altered by a chemical are substantially solids mixed in with the slurry. In another embodiment, the siliceous particles comprise about 10 wt. % or more of the slurry, more preferably about 20 wt.%, more preferably about 30 wt. %, more preferably about 50 wt.%. The multi-function additive composition can further comprise an aluminosilicate material wherein the aluminosilicate material is dispersed in the slurry. In another embodiment, the multi-function additive composition is in a paste form, comprising substantially the siliceous material having at least one region altered by a chemical. In yet another embodiment, the multi-function additive composition is in the form of a plurality of agglomerated particles formed of the alkaline activation compound in combination with the siliceous particles having at least one region altered by a chemical. The agglomerated particles preferably are comprised of the siliceous particles having at least one region altered by a chemical bound together by the alkaline activation compound. Preferably, the weight percentage of the siliceous particles is at least equal to or greater than the weight percentage of the alkaline activation compound. Preferably, the agglomerated particles have a bulk density of less than or equal to about 1,500 kg/m³.

In yet another aspect, the preferred embodiments of the present invention provide a method of forming a multi-function additive for settable composite materials. The method comprises the steps of (a) providing at least a siliceous material and at least an alkali compound, (b) reducing the particle size of the siliceous material, and (c) reacting the siliceous material with the alkali compound in a manner so as to form a mixture comprising alkali silicate and a plurality of modified low density siliceous particles wherein each particle has at least a first portion that is morphologically and/or chemically altered by the alkali compound and at least a second portion that is not morphologically and/or chemically altered by the alkali compound. Preferably, the one or more altered regions on each particle comprise about 0.1%-95% of the volume of the particle. Preferably, at least one region of the siliceous material remains unaltered from the original material. The alkali compound is preferably selected from the group consisting of alkali metal hydroxides, alkaline earth metal hydroxides, weak-acid alkali metal salts, alkaline silicates and combinations thereof. In one embodiment, the method further comprises adding the multi-function additive to a settable composite material composition to accelerate the rate of setting and hardening and reduce the density of the composite material. Preferably, the composite material includes aluminosilicate and a calcium-bearing cementitious material such as Portland cement, aluminous cement, fly ash, blast furnace slag, cement kiln dust which can further contribute to setting and hardening of the composite material.

In a preferred embodiment, the step of providing a siliceous material and an alkali compound comprises combining a siliceous material and an alkali compound to form an aqueous slurry. The step of reacting the siliceous material with the alkali compound to form modified low density siliceous material preferably comprises exposing the siliceous material to heat sufficient amount of time to promote digestion of the siliceous material. In one embodiment, the steps of reducing the particle size of the siliceous material and exposing the siliceous material to heat occur substantially simultaneously in the same process. In one preferred embodiment, the step of reacting the siliceous material with the alkali compound preferably comprises reacting at atmospheric pressure. The step of reducing the particle size of the siliceous material preferably comprises milling the siliceous material in a wet process carried out in the aqueous slurry containing the alkali compound. In another preferred embodiment, the steps of reducing the particle size of the siliceous material and reacting the siliceous material with the alkali compound occur by dry or wet milling of the siliceous material followed by combining with alkali compound to form a mixture containing the alkali silicate and the modified low density siliceous particles. In one implementation, the mixture containing the alkali silicate and the modified low density siliceous particles is a slurry. In some embodiments, the method further comprises a suitable method for drying the slurry to form agglomerated particles comprised of the modified siliceous particles with some alkali silicate gel in between. In certain embodiments, the method further comprises the step of adding an aluminosilicate material to the slurry. In a preferred embodiment, the modified low density siliceous particles comprise about 10 wt. % or more of the mixture. In another embodiment, the method further comprises separating the modified low density siliceous particles from the alkali silicate.

In yet another aspect, the preferred embodiments of the present invention provide a method of forming a multi-function additive for settable composite materials containing aluminosilicate. The method comprises (a) providing at least a siliceous material and at least an alkali compound, (b) forming an alkali silicate material, (c) forming a plurality of low density siliceous particles, wherein each particle has at least one gel-like region, wherein the low density siliceous particles lower the density of the composite material. Preferably, the alkali silicate material and the low density, siliceous particles are formed substantially simultaneously in a same process. In one embodiment, the process is a mechano-chemical process in which siliceous material is substantially simultaneously milled and chemically reacted with an alkali compound to form the alkali silicate and the low density siliceous particles.

In yet another aspect, the preferred embodiments of the present invention provide a method of accelerating the hardening of a settable composite material comprising aluminosilicate and modifying the density of the material. The method comprises (a) providing a mixture comprising water glass and a plurality of low density siliceous particles having one or more regions that are altered by an alkali compound, (b) adding the mixture to the composite material composition, and (c) reacting the mixture with the aluminosilicate in the composite material composition. In one embodiment, the composite material composition comprises a binder selected from the group consisting of Portland cement, water glass, and combinations thereof. In another embodiment, the mixture increases the rate of hardening of the composite material by about 5%-100,000% as compared to an equivalent composite material without the mixture. In yet another embodiment, the mixture enables the composite material to harden without being substantially subjected to a hydrothermal condition and/or without the need of being subjected to a hydrothermal condition. In yet another embodiment, the mixture lowers the density of the composite material by about 0.1%-50% as compared to an equivalent composite material without the mixture.

In yet another aspect, the preferred embodiments of the present invention provide a settable composite material comprising a binder, an aluminosilicate material, and a multi-function additive comprising alkali silicate and a plurality of modified low density siliceous particles having a first region that is morphologically and/or chemically altered by a chemical and each of the modified low density siliceous particles also have a second region that is not morphologically and/or chemically modified by the chemical. Preferably, the additive reacts with the aluminosilicate to increase the rate of hardening of the composite material and wherein the low density siliceous particles lower the density of the composite material. In one embodiment, the composite material is a cementitious composite material, preferably fiber reinforced cementitious composite material such as a fiber cement panel, a fiber cement pipe, or a fiber cement cladding board. In one embodiment, the binder in the composite material comprises water glass. Preferably, the multi-function additive increases the rate of hardening of the composite material by about 5%-1000% as compared to an equivalent composite material without the multi-fiction additive. In yet another embodiment, the mixture enables the composite material to harden without the need of being subjected to a hydrothermal condition. In another embodiment, the composite material further comprises un-altered low density additive. Preferably, the multi-fiction additive lowers the density of the composite material by about 0.1%-50% as compared to an equivalent composite material without the multi-function additive.

In yet another aspect, the preferred embodiments of the present invention provide a multi-function additive for settable composite materials. The additive comprises a slurry, wherein the slurry comprises an alkaline activation compound and a plurality of low density siliceous particles. Preferably, the low density siliceous particles comprise about 10% or more of the dry weight of the solution. In one embodiment, the alkaline activation compound consists essentially of sodium silicate. In another embodiment, at least a portion of the low density siliceous particles have one or more partially digested regions.

In yet another aspect, the preferred embodiments of the present invention provide a low density brick. The brick comprising a plurality of siliceous particles, wherein each particle has at least one region that is altered by a chemical, wherein the at least one region comprises about 0.1%-90% of the volume of the particle. Preferably, the siliceous particles comprise silicates partially dissolved by an alkali compound. Preferably, the siliceous particles have a bulk density of about 1,500 kg/m³ or less. In another embodiment, the low density brick further comprising a binder which binds the siliceous particles together. In yet another embodiment, the low density brick further comprises reinforcement fibers.

### BRIEF DESCRIPTION OF THE DRAWINGS

FIG. 1 illustrates a preferred process flow for manufacturing a multi-function additive of one preferred embodiment of the present invention;

FIGS. 2A and 2B are SEM images illustrating spray-dried additive A and B respectively derived from composite additive slurries of certain preferred embodiments;

FIG. 3 is a SEM image showing a composite additive of a preferred embodiment showing a porous agglomerated particle formed of spray dried slurry of one preferred embodiment;

FIG. 4 is a SEM image showing a composite additive of a preferred embodiment showing the morphologically altered regions of the siliceous particles; and

FIG. 5 is a SEM image showing a composite additive of a preferred embodiment in the form of small aggregates agglomerating together to form larger agglomerate encased in a thin coating of sodium silicate.

### DETAILED DESCRIPTION OF PREFERRED EMBODIMENTS

Disclosed herein is a multi-function additive composition of certain preferred embodiments for incorporation into a settable composite material. The composition of the preferred embodiment is formulated to modify the density and increase the rate of hardening or strength development of the composite material. Surprisingly, it was discovered that the novel additive composition enables settable composite material to harden without the need to be subjected to a hydrothermal condition such as that in an autoclave. Also disclosed are methods for making the additive and also the settable composite materials incorporating the additives. The additive compositions and methods of manufacturing can be advantageously used, for example, in producing air-cured, steam-cured, or hydrothermally-cured building materials, and in particular, fiber cement building products. Of course, the novel multi-function additive can also be incorporated into other uses, such as, for example, polymers, detergents, abrasives, glass and ceramic articles, and coatings.

Composition of the Multi-function Additive

A preferred composition of the multi-function additive generally comprises an alkaline activation compound and a plurality of modified low density siliceous particles. Each modified siliceous particle preferably has one or more regions that are morphologically and/or chemically altered by a chemical compound. In one embodiment, each siliceous particle also has one or more regions that remain substantially un-altered by the chemical compound. In a preferred embodiment, the morphologically and/or chemically altered regions comprise a part of the exterior surfaces of the particle and the un-altered regions primarily comprise the core of the particle. In certain implementations, the altered regions are in a gel-like, semi-solid, rough, spiky, edgy, coral-like, clustered and/or porous state, which can primarily result from the siliceous material being partially dissolved, reacted, digested, leached and/or softened by a chemical compound such as an alkali compound. In some implementations, the morphologically altered regions are also chemically altered. In one embodiment, the one or more morphologically and/or chemically altered regions comprise about 0.1%-90% of the volume of the particle. As will be described in greater detail below, the modified low density siliceous particles can be processed from a variety of different silicate- or silica-based materials such as feldspar, basalt rock, tuff, volcanic ash, obsidian, diatomaceous earth, reactive clay, waste glass, slag, cement kiln dust, fly ash, bottom ash, incinerator ash, coal beneficiation rejects, silica fume, silica dust, rice hull ash, silica, clay, glass, pulverized rocks, and red mud.

In a preferred embodiment, the alkaline activation compound comprises an alkali silicate or silica enriched alkali silicate such as sodium silicate, potassium silicate, lithium silicate, or combinations thereof. In one implementation, the composition consists essentially of sodium silicate or water glass and the modified low density siliceous particles consisting essentially of a silicate-based material having at least one partially dissolved, gel-like exterior region. Preferably, the weight percent of the modified low density siliceous particles in the multi-function additive is greater than or equal to the weight percent of the alkali silicate on a dry basis. In another embodiment, the weight percent of the modified low density siliceous particles is greater than or equal to about 10 wt. % of the additive by dry weight, more preferably greater than or equal to about 30 wt. % of the additive by dry weight. Advantageously, the modified low density siliceous particles not only function as a low density additive in the matrix but combine synergistically with the alkaline activation compound to increase the rate of hardening or strength development in a settable composite matrix containing aluminosilicates. The settable matrix can include a number of different materials including but not limited to aluminosilicate material, calcareous material, cement, fiber cement, gypsum composite, polymers, and composites thereof. Without being bound by theory, it is suggested that there are many factors contributing towards acceleration in setting and hardening by the additives. These factors may possibly include, but not limited to, hardening/hydration reaction due to an increased degree of cross-linking of silicon atoms in the alkali activation compound or the reactive surface of the siliceous materials.

In certain preferred embodiments, the multi-function additive increases the rate of hardening or strength development in settable composite matrix by about 5% or more, preferably about 5%-1000%, preferably about 50%-500%, as compared to an equivalent composite matrix without the additive. In some embodiments, the multi-function additive increases the rate of hardening or strength development in settable composite matrix up to about 1,000 times as compared to an equivalent composite matrix without the additive. In other embodiments, the multi-function additive also lowers the density of a composite material by about 0.1%-100%, preferably about 10%-50%, as compared to an equivalent composite matrix without the additive. In yet another embodiment, the additive enables the composite material to harden substantially without the need of being subjected to a hydrothermal condition.

Physical forms of the multi-function additive

The multi-function additive can assume a number of different physical forms. In one embodiment, the alkaline activation compound such as alkali silicate and the modified low density siliceous particles are mixed together in solution, such as in a slurry or suspension. Preferably, the alkaline activation compound is dissolved in the solution and the modified low density siliceous particles are mixed in the solution as substantial solids. In another embodiment, the alkali silicate (alkaline activation compound) and the low density siliceous particles are combined together in an agglomerated particle form with the siliceous particles bound by the alkali silicate gel positioned in between the particles. As will be described in greater detail below, the agglomerated or clustered particles are preferably formed by thermal spraying the solution or slurry containing the alkaline activation compound and siliceous particles. An alternative is to form the agglomerated particles by, for example, oven or kiln drying the slurry, then grinding the dried material. In this embodiment, the bulk density of the multi-function additive is preferably less than or equal to 1,500 kg/m³.

Raw Materials

The raw materials used to form a multi-function additive of the preferred embodiments of the present invention generally include a silicate-based material, an alkali compound, and optionally an inorganic filler.

Silicate-based Material

As defined herein, the term silicate shall refer to a chemical compound comprises silicon and oxygen. In some preferred embodiment, the silicate may optionally comprise one or more metal oxides of aluminium, calcium, iron, magnesium, manganese, potassium, sodium, zirconium, phosphorous, boron, etc. The silicate-based material as used herein may consist entirely of silica and/or silicate, consist essentially of silica and/or silicate, comprise substantially of silica and/or silicate, or comprise silicate and other materials. It is generally known that silicates are widely distributed in nature. Most of the common rock-forming minerals are made of silicates. However, the silicate-based material used herein may include natural or synthetic silicates or those formed as a by-product from other processes, or combination thereof.

Natural silicates can include a broad range of silicates such as selected silicate minerals, those containing vitrified silicate phases such as feldspars, basalt rock, tuff, and others such as volcanic ash, obsidian, diatomaceous earth and reactive clays. Synthetic or by-product silicates can include calcined clays and silica-rich sources of industrial waste such as waste glass, slags, silica fume, silica gel, silica flour, cement kiln dust, fly ash, bottom ash, incinerator ash, coal beneficiation rejects, among other suitable synthetic silicate sources.

The silicate-based material may be obtained from one or a combination of suitable silicate sources. One preferred source of silicate is a low cost recycled material. One source of low cost recycled material can be obtained from glass, preferably recycled waste glass such as glass cullet obtained by grinding waste glass such as sorted glass from municipal waste, scraps of glass plates or glass bottles from glass manufacturing and processing plants, and construction and demolition waste glass. Most waste glass consists essentially of silicon, sodium, and calcium oxides (referred to as soda-lime glass) with other minor components, such as aluminum and magnesium oxides.

Another preferred source of silicate is a low cost industrial waste product, such as granulated blast furnace steel slag which is generally a calcium-alumino-silicate glassy material formed during a metal refining process. A typical composition comprises about 33-35% SiO₂, about 14-18% Al₂O₃ and about 38-45% CaO. Granulated blast furnace slag is usually produced by quenching molten slag removed as waste product from the bottom of a blast furnace. Because the molten slag is quenched, granulated blast furnace is mostly vitrified without being crystallized. Another effective low cost industrial waste product is fly ash, typically comprises about 66-68% reactive alumino-silicate (amorphous) glass produced when pulverized coal is burned in electric power plants.

In a preferred embodiment, the silicate-based material has a silica (SiO₂) content of about 30 wt % or more by weight, preferably about 40 wt % or more by weight, and more preferably about 50 wt % or more. In another preferred embodiment, the silicate-based material is preferably finely ground using techniques to be described in greater detail below. In another preferred embodiment, the silica content of the silicate based material is less than 100%, preferably less than 90%, more preferably less than 80%.

Alkali Compound

As defined herein, an alkali compound refers to one or more base compounds such as alkali metal hydroxides, alkaline earth metal hydroxides, weak-acid alkali metal salts, alkali silicates or any other compounds that dissolve in an aqueous solution and releases hydroxide ions (OH)⁻. Examples of suitable alkali metal hydroxides include sodium hydroxide NaOH, potassium hydroxide KOH, and lithium hydroxide LiOH. The alkali metal is preferably one of a combination of sodium, potassium, and lithium. Examples of suitable alkaline earth metal hydroxides include calcium hydroxide Ca(OH)₂ and magnesium hydroxide Mg(OH)₂. Examples of weak-acid alkali metal salts include sodium carbonate, potassium carbonate, sodium silicate, potassium silicate, sodium aluminate, and potassium aluminate. It may also include alkali carbonate and bicarbonate, silicates, borates, and aluminates.

As will be described in greater detail below, the alkali compound and the silicate-based material are preferably mixed together in an aqueous slurry. The compound in the aqueous slurry reacts with the silicate-based material to form alkali silicate and aluminate. In this case, the pH of the resulting solution remains below 14, preferably below 13, and most preferably below 12. Thus, in certain preferred embodiments, the weight ratio between the alkali compound and silicate-based material depends largely on the mole ratio of (OH)⁻ in the alkali compound to SiO₂ in the silicate based material. In certain implementations in which soda lime waste glass is used as a silicate source and sodium hydroxide is used as an alkali compound, the mass percentage of hydroxide on a dry basis with SiO₂ has an upper limit range of about 45-50 wt % by weight, preferably about 25-30 wt % by weight, more preferably about 5-10 wt. % However, in certain embodiments, high pH such as 14 or above may be preferred since high pH facilitates the activation of the aluminosilicate in the settable matrix. In embodiments in which a higher pH is desired, a higher percentage of hydroxide is used, preferably in the range of between about 45%-50%.

Preferably, the weight ratio between the alkali compound and the silicate-based material is such that a substantial amount of solids remains after the reaction. In a preferred embodiment, the reaction between the alkali compound and the silicate-based material is configured to produce alkali silicates and modified siliceous solids. The modified siliceous solids have one or more regions of morphologically and/or chemically altered silicate-based material as well as regions of un-reacted original silicate-based material. This is contrary to conventional wisdom as the common methods of forming alkali silicates such as sodium silicate involve high temperature reactions that tend to produce relatively pure sodium silicates without any residual solids.

Inorganic Fillers

Inorganic fillers could optionally be incorporated into the alkaline activation compound to manipulate the composition and density of the siliceous particles. In embodiments where sodium silicate (water glass) is used as a source of silicate, an inorganic filler can be used to adjust the SiO₂/Na₂O molar ratio of the water glass. For example, a reactive siliceous source such as Microsilica (“silica fume” formed as by-product from the production of silicon and ferrosilicon metal) can be utilized to increase the SiO₂/Na₂O molar ratio of water glass. Other examples include rice hull ash and colloidal silica such as silica gel. An alkali and lime source such as cement kiln dust or slag may also be added to provide lime to enrich the composite additive with calcium silicate, and at the same time increase the ratio of SiO₂/Na₂O in the sodium silicate. It may be advantageous to promote or increase the formation of calcium silicate as a low density residual material, since calcium silicate is fully compatible with Portland cement, and is known to form light weight tobermorite phase when hydrothermally heated.

Aluminosilicate

In certain embodiments in which the multi-function additive is in a slurry form, the composition can further include an aluminosilicate material. The aluminosilicate material can be selected from a group of fly ash (type F, type C, etc.), bottom ash, blast furnace slag, paper ash, basaltic rock, andesitic rock, feldspars, aluminosilicate clays (calcined or non calcined) (kaolinite clay, illite clay, bedalite clay, bentonite clay, china, fire clays, etc.), bauxite, obsidian, volcanic ash, volcanic rocks, volcanic glasses, or combination thereof. As described above, the additive is formulated to react with aluminosilicate in the settable composite material in order to increase the rate of hardening of the material or enable hardening without a hydrothermal condition. This embodiment contemplates including the aluminosilicate as part of the additive composition in the slurry. This embodiment provides advantages including better control of the amount of aluminosilicate (reactive material) that will react with the alkaline activation compound.

Process for Forming the Composite Additive

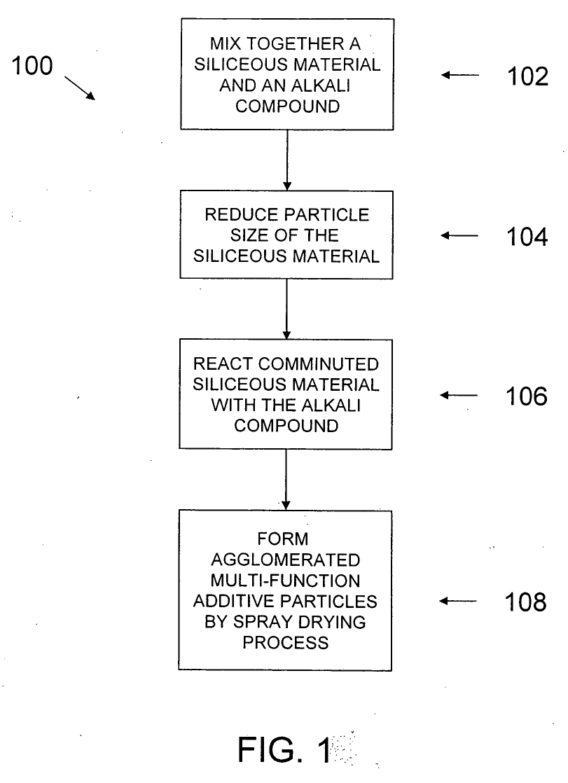

FIG. 1 illustrates a preferred process 100 for forming the multi-function additive described above. The process 100 begins with Step 102 in which a siliceous material and an alkali compound are mixed together. Preferably, the siliceous material and the alkali compound are mixed in an aqueous solution such as a slurry. The process continues with Step 104 in which the particle size of the siliceous material is reduced. The siliceous material can be comminuted by suitable wet or dry milling processes. In some embodiments, the siliceous material is co-comminuted with the alkali compound. In Step 106, the siliceous material is reacted with the alkali compound. Preferably, a portion of the siliceous material is fully digested or dissolved by the alkali compound to form alkali silicate while another portion of the siliceous material remains substantially undigested with only portions of the material partially reacted, softened and/or dissolved by the alkali compound. In one embodiment, the reaction takes place in an aqueous solution where the siliceous material is reacted with the hydroxides released by the alkali compound. In an optional embodiment, heat can be used in this step to further promote the digestion of the siliceous material. In some preferred embodiments, Steps 104 and 106 are performed simultaneously so that the siliceous material is mixed with the alkali compound while being comminuted so that the size-reduction and chemical digestion processes can take place simultaneously in the same process. In some preferred embodiments, mixing, size reduction and heating can be performed simultaneously. As FIG. 1 further shows, in the embodiments where the resultant additive (alkali silicates and siliceous particles with partially digested regions) is in a slurry form, the process 100 optionally further includes thermal spraying the slurry to obtain agglomerated particles comprised of siliceous particles bound together by the alkali silicate.

While other processes may be invoked to process the raw materials to result in the novel compositions and articles discussed herein, many preferred processes generally include a two-stage processing as described below, which involves mechano-chemical treatment by wet milling followed by digestion/condensation by heating.

Stage 1: Mechano-chemical Treatment by Wet Milling

In this stage, diluted slurry of silicate material such as crushed recycled soda-lime glass cullet, is milled together with an alkali compound such as sodium hydroxide, sodium silicate or soda ash for a desired period of time, such as for 5 minutes to 3 days, often depending on the processing temperature. Optionally, heat and/or amorphous silica are introduced during milling to maximize the extent of silica dissolution in this stage. Of course, other milling techniques may be used prior or during digestion including ball milling, jet milling, fluid energy transfer milling and roller milling to reduce the particle size and increase the overall surface area. Without being bound by theory, it is suggested that the mechano-chemical treatment exposes reactive surface of silica which leads to a synergistic setting and hardening performance of the novel composition of this invention.

Stage 2: Digestion by Heating

The slurry from stage 1 is heated for a period of time, preferably less than 24 hours, more preferably less than 12 hours, in an open or pressurized tank at heating temperatures ranging in one embodiment between about 60 to 140° C. Generally, higher digestion temperatures require shorter digestion times. The resulting slurry preferably comprises an alkaline activation compound such as alkali or alkali metal silicate and a low density solid having one or more partially digested or altered regions. The alkaline activation compound preferably has a SiO₂/ R₂O molar ratio ranging between about 1.0 to 5.0, with a lower limit of about 5 wt % of the slurry, preferably about 20 wt % by weight, more preferably 40 wt %. (where R preferably refers to Na, K, and/or Li.)

The low density solids preferably have a dry bulk packed density ranging between 250 and 1500 kg/m³. In one embodiment, the low density solids have a lower concentration limit of about 10 wt. %, preferably about 20 wt%, more preferably about 30 wt % of the slurry. Due to differential reaction, leaching and/or digestion, the low density solids may have portion of the surfaces rich in certain compounds. For example, for soda lime glass source material, after some silica reacted, the resulting low density solid particles may have a part of their surfaces rich in calcium, aluminum and/or magnesium oxide. In some embodiments, the alkaline activation compound such as the alkali metal silicate and low density solids are subsequently dried and granulated. Drying and granulation can be done in a single step, such as in a spray dryer or the like, or may be performed in multiple steps, such as in a kiln, following by a ball mill. However, the novel composite additive could be utilized in slurry form or paste form, dried and used in a powder or aggregates form, or filtered to a slurry or a paste form and used separately.

The alkali metal silicate in conjunction with the low density solids provides a novel density-modifying rapid hardening accelerator. The novel density-modifying rapid hardening accelerator described in the present disclosure can be further combined with a reactive aluminosilicate material to form additional low density composite materials. Examples of aluminosilicate materials include dehydroxylated clays, GGBFS (granulated ground blast furnace slags) and fly ash, among others.

Settable composite materials incorporating the multi-fiction additives

The multi-function additives can be incorporated in a wide variety of settable composite materials to accelerate the rate of hardening or strength development of the settable material while at the same time modifying the density of the material.

Fiber Cement Composite Material

In one embodiment, the additive is incorporated in a fiber cement composite material containing aluminosilicate, preferably a fiber cement matrix reinforced with cellulose fibers and/or other fibers. The fiber cement matrix can be in the form of a fiber cement cladding sheet, panel, post, pipe, or shaped articles. More detailed descriptions on the formations and processes in making the fiber cement composite material are described in U.S. Pat. No. 6,872,246, which is incorporated by reference in its entirety. In one embodiment, the multi-function additive can be incorporated into the fiber cement in slurry form. The fiber cement slurry is then formed into green-shaped article by any of a number of conventional processes. These processes include the Hatcheck sheet process, the Mazza pipe process, the Magnani sheet process, injection molding, extrusion, hand lay-up, molding, casting, filter pressing, flow on machine roll forming, and other suitable processes, with or without post-formation pressing. Advantageously, the composite additive speeds up the set time and hardening of the fiber cement material while providing a low density filler to the material. Advantageously, the composite additive enables hardening of the fiber cement material without the need of autoclaving.

In one embodiment, the fiber cement composite material formulation comprises:

about 20-50% binder such as Portland cement, gypsum cements, calcium aluminous cements, pozzolanic cements, lime cement, and calcium and magnesium phosphate cements or water glass;

about 30-70% finely ground silica;

about 2-20% cellulose fibers; and

about 1%-50% multi-function additive of a preferred embodiment.

In certain implementations, the formulation further comprises commercially available un-altered low density additives. Advantageously, the multi-function additive of a preferred embodiment is formulated to increase the rate of hardening of the fiber cement composite material made according to the above formulation by about 5%-1000%, preferably about 5%-200%, as compared to a fiber cement composite material made with an equivalent formulation but without the additive. Additionally, the multi-function additive of a preferred embodiment is also formulated to lower the density of the fiber cement composite material made according to the above formulation by about 0.1%-500%, preferably about 5%-100%, as compared to a composite material made with an equivalent formulation with a commercially available, un-altered low density additive substituting for the multi-function additive.

### EXAMPLES

Example 1 illustrates the preparation a multi-function additive of one embodiment using a preferred two-stage process as described above. A slurry(1) was prepared with the following composition: (a) about 400 gm of siliceous material in the form of finely ground recycled soda lime glass sand with an average particle size of about 380 microns, (b) about 28 mg of an alkali compound in the form of NaOH, (c) about 40 gm of mineral filler, Elkem Microsilica Grade 940 (SiO₂ content >90%), and (d) about 1900 ml water. The oxide composition of the recycled soda lime glass used in this example is shown below in Table 1.

TABLE 1
Oxide composition of recycled soda lime glass used in Example 1

| | % |
|---|---|
| Oxides | Weight |
| SiO₂ | 71.07 |
| Na₂O | 14.2 |
| CaO | 11.14 |
| Al₂O₃ | 1.47 |
| K₂O | 0.516 |
| MgO | 0.466 |
| Fe₂O₃ | 0.324 |
| SO₃ | 0.13 |
| TiO₂ | 0.069 |
| LOI | 0.43 |

The slurry was processed in the two-stage process described above, which included milling the slurry containing the siliceous material for about 60 minutes in a 1.5 gallon Szegvari laboratory batch attritor mill, and placing a 200 ml sample on a heating element and heating it to boiling temperature. Once boiling, the sample was heated for about 90 minutes to allow the alkali compound to react with and digest the siliceous material. The slurry properties throughout the two-stage process are shown in Table 2.

TABLE 2
Properties of slurry (1) throughout the 2-stage process.

| | | After milling | After |
|---|---|---|---|
| Slurry | Before | (size reduction/ | boiling |
| Properties | milling | alkaline activation) | (digestion) |
| % Solids | 19.76 | 19.76 | 23.59 |
| Density (gm/ml) | 1.1 | 1.1 | 1.23 |
| Particle Size | | | |
| Distribution | | | |
| d(0.90), μm | 578.15 | 2.43 | 3.03 |
| d(0.50), μm | 261.42 | 5.11 | 6 |
| d(0.10), μm | 58.50 | 11.62 | 12.31 |
| Viscosity (cps) | | 100 | 400 |

It can be seen that the average particle size of the siliceous material in the slurry was reduced from about 261.4 microns before milling to about 5.1 microns after milling, changing to about 6 microns after boiling. The average particle size of the siliceous materials in the slurry increased slightly after boiling possibly because a portion of the smaller particles have dissolved during the boiling/digestion process. The novel composition comprising a sodium silicate and low density siliceous particles with partially digested regions were formed at this point.

What follows is a description of the tests used to characterize the novel composition formed above. After heating/digestion was completed, the sample was hot filtered through a 0.8 um cellulose nitrate membrane filter to separate the liquid phase (sodium silicate or water glass) from the solid phase (low density siliceous particles with partially digested regions). The liquid phase was diluted for Inductively Coupled Plasma Spectrometry (ICP) analysis. The solid phase was dried at 105° C. for a minimum of 12 hours, crushed and, using a shaking table, tested for loose and packed densities. The properties of the liquid and solid phases in the boiled slurry are shown in Table 3.

TABLE 3
Properties of liquid and solid phases in the
multi-function additive in slurry form.

(Based on analysis of 200 ml
slurry sample)

| | Liquid Phase | Dried Solid Phase |
|---|---|---|
| Oxides | Composition (gm) | Composition (gm) |
| Fe₂O₃ | 0 | 0.29 |
| MgO | 0 | 0.2 |
| TiO₂ | 0 | 0.02 |
| CaO | 0 | 4.10 |
| Al₂O₃ | 0.03 | 1.11 |
| K₂O | 0.05 | 0.25 |
| Na₂O | 2.73 | 4.4 |
| SiO₂ | 8.16 | 28.34 |
| Water in the phase (gm) | 47.50 | 63.49 |
| Solids in the phase (gm) | 10.97 | 38.73 |
| SiO₂/Na₂O weight ratio | 2.99 | 6.44 |
| % Water glass in | 22 | |
| total solids | | |
| % siliceous material | 78 | |
| in total solids | | |
| Bulk density of | 336 | 431 |
| solid phase, gm/cm³ | (loose) | (packed) |

As seen in Table 3, the multi-function additive in slurry form produced in this example by the two-stage process of a preferred embodiment contained about 22% water glass (sodium silicate SiO₂/ Na₂O weight ratio =2.99) and about 78% low density siliceous particles, both calculated as % of total solids. The fact that significant silicate dissolution took place at atmospheric pressure and 100° C. is quite surprising. This is contrary to current theory and practice in which high pressures and temperatures are required for producing water glass. Without wishing to be bound by theory, it is believed that the milling process exposes additional surface area that may be more reactive than the previously exposed surfaces prior to milling. Contrary to conventional sodium silicate manufacturing processes, in which the raw materials are formulated and the process engineered to maximize the volume of the liquid phase and minimize or eliminate the solid phase, the present disclosure teaches a method of increasing the siliceous solids.

Example 2 illustrates a comparison of the setting and hardening properties of a fiber cement composite material containing the novel multi-function additive composition described in Example 1 and a fiber cement composite material containing commercial sodium silicate and un-altered low density additives (LDA) in place of the multi-function additive composition.

Two lightweight fiber-reinforced cement-based mix compositions were prepared using formulations shown in Table 4 and processes known in the art. Mix (A) contains commercial grades of un-altered LDA as density modifier and sodium silicate (water glass) as setting/hardening accelerator. Mix (B) contains the multi-fiction additive slurry produced in Example 1 substituting for the water glass and un-altered LDA commercial additives. The other components of Mixes A & B are substantially identical except for the small percentage variation in the amount of silica.

The mixes were extruded using a single screw extruder. Setting and hardening times of the green material were measured using a modified soil penetrometer, the results of which are shown in Table 5.

Extruded samples representing mixes A and B were wrapped in plastic and left to cure in an equilibrium room (about 20° C. room temperature, 50% relative humidity) for 7 days. The samples were prepared to be about 50 mm (2 in) wide and 11 mm (½in) thick, and were then tested in flexure at about a 215 mm (8.5 inch) span in equilibrium conditions. The mechanical properties for the mixes (saturated and equilibrium conditions) are compared in Table 6.

TABLE 4
Mix compositions A and B (containing commercial
additives and novel slurry (1) respectively)

| | Mix A | Mix B |
|---|---|---|
| | (containing | (containing |
| | commercial | novel additive |
| | additives) | slurry (1)) |
| Dry Weight, g | 11000 | 11000 |
| Moisture, W/(W + S) | 43% | 43% |
| W/S | 75.44% | 75.44% |
| Mix Ingredients | % (Dry wt) | % (Dry wt) |
| Cellulose fiber | 9% | 9% |
| Cellulose Ether | 1.5% | 1.5% |
| Potassium Carbonate | 1.5% | 1.5% |
| Sodium Silicate | 3% | |
| (Type N - PQ Corp.) | | |
| Commercial LDA | 10% | |
| (Microcel E) | | |
| Novel Additive | | |
| Assumed components | | |
| (as per table 3) | | |

| | |
|---|---|
| Water glass | |
| LDA | 15% |

| | | |
|---|---|---|
| Metakaolin (4.6 um | 6% | 6% |
| average size) | | |
| Cement | 40% | 40% |
| Silica | 29% | 27% |

TABLE 5
Setting and hardening times for extruded
green pastes representing mixes A and B.

| | Setting Time | Hardening Time |
|---|---|---|
| | (minutes) | (minutes) |
| Mix A | 53 | 106 |
| Mix B | 49 | 98 |

As used herein, the Setting Time is the time taken to attain about 4.75 tons per square foot nominal reading using a 6 mm (0.25 inch) diameter loading piston plunged into green paste to a depth of 6 mm (0.25 inches). The Hardening Time is the time taken to attain about 4.75 tons per square foot nominal reading using a 6 mm diameter loading piston plunged into green paste to a depth of 1 mm. From Table 5 it can be seen that Mix A containing commercially available, un-altered LDA and sodium silicate took longer to both set and harden in comparison with Mix B which contained the novel multi-function additive slurry of one preferred embodiment. What is also unexpected is the comparison of flex properties from samples produced from each Mix as shown in Table 6.

TABLE 6
Seven-day flex properties of extruded samples produced from Mixes A and B

| | | Modulus of | Modulus of | Ultimate | Oven-dry |
|---|---|---|---|---|---|
| | Curing | rupture | Elasticity | Strain/1000 | Density |
| | Method | (MPa) | (GPa) | Micro mm/mm | gm/cm³ |
| Mix A (saturated) | 7 day Air-Cure | 2.2 | 0.83 | 4.49 | 1.31 |
| Mix B (saturated) | 7 day Air-Cure | 5.425 | 2.31 | 6.85 | 1.35 |
| | Autoclave-Cure | 5.92 | 2.52 | 2.57 | 1.47 |
| Mix A (equilibrium) | Air-cure | 3.72 | 1.68 | 4.59 | 1.1 |
| Mix B (equilibrium) | Air-Cure | 6.07 | 1.9 | 5.88 | 1.07 |

It can be seen Mix B exhibited shorter setting and hardening times (Table 5) as compared to Mix A, which demonstrated the potency and synergistic effect of the novel multi-function additive as a hardening accelerator. Additionally, the samples produced from the two mixes exhibited comparable density (Table 6) indicating the effectiveness of the multi-function additive as a density modifier. Additionally, the fact that the siliceous particles with partially digested regions in the slurry exhibited similar density-modification effects compared to the commercial un-altered low density additives is also quite surprising.

Saturated conditions

Referring to Table 6, it can also be seen that under saturated conditions, Mix B containing the novel multi-function additive slurry exhibited about 2.5 times higher in 7-day strength as compared to Mix A which contained commercially available un-altered low density additive and setting/hardening additives. This surprising result demonstrated the functionality of the novel additive as a hardening accelerator for air-cured fiber-reinforced cement-based composites.

The fact that modulus of rupture (MoR) for Mix B in 7-day air-cure was comparable to its MoR value in autoclave conditions is also quite surprising, as air-cured mixes are expected to require much higher levels of cements (up to 80% of total weight) and longer air-dry cure times to achieve such strength levels. The results show that incorporating Mix B into cementitious formulations can produce air-cured and autoclaved articles having similar modulus of rupture (MoR), modulus of elasticity (MoE), and density characteristics. Moreover, the products incorporating the novel slurry exhibit a much greater MoR and MoE, thus providing superior strength and handleability characteristics.

Equilibrium conditions

Significant improvement (about 63% increase) in 7-day strength is also observed for mix B as compared to mix A. This is quite unexpected, as both commercial additives and novel multi-function additive slurry were expected to exhibit similar alkaline activation effects on the reactive aluminosilicate material, which in this particular example was metakaolin.

Example 3 illustrates further options for producing the novel multi-function additive by alkaline activation and digestion.

To demonstrate the robustness of the alkaline activation and digestion process of the preferred embodiments, a slurry(2) was prepared by milling medium-fineness recycled soda lime glass (about 32 microns average size) in a 1.5 gallon Szegvari laboratory batch attritor mill without the alkaline activator. The milled slurry was heated to a boil with an alkaline activator, mineral filler (microsilica) and water for 3 hours in a 5-Gallon Agitated Batch Heating Tank.

Slurry (3) was prepared by boiling the glass with the alkali compound without wet milling. Slurry (3) was prepared by boiling fine recycled soda lime glass (about 16 microns average size) with an alkaline activator (NaOH) and mineral filler (microsilica) for 3 hours in a 5-Gallon Agitated Batch Heating Tank. The properties of slurries (2) & (3) are shown in tables 7, 8.

TABLE 7
Properties of Slurry (2) throughout the process.

| | | | After boiling |
|---|---|---|---|
| | Before milling | After milling | (digestion/alkaline |
| Properties | Glass | (size reduction) | activation) |
| % Solids | 17.39 | 17.39 | 25.6 |
| Density (gm/ml) | 1.1 | 1.1 | 1.27 |
| Particle Size | | | |
| Distribution | | | |
| d(0.90), um | 97.060 | 10.121 | 39.246 |
| d(0.50), um | 32.556 | 4.139 | 7.878 |
| d(0.10), um | 6.495 | 2.101 | 3.1 |
| Viscosity (cps) | | 100 | 440 |

TABLE 8
Properties of Slurry (3) throughout the process.

| | | Slurry after boiling |
|---|---|---|
| | Glass Before | (alkaline activation/ |
| Properties | Boiling | digestion) |
| % Solids | | 23.84 |
| Density (gm/ml) | | 1.25 |
| Particle Size | | |
| Distribution | | |
| d(0.90), um | 40.895 | 33.182 |
| d(0.50), um | 15.732 | 12.612 |
| d(0.10), um | 4.941 | 4.118 |
| Viscosity (cps) | | 360 |

Two lightweight fiber-reinforced cement-based mixes (Mixes C & D) were prepared according to the formulations shown in Table 9, containing slurries 2 and 3 respectively. In comparison with commercially available Mix A, Mix C substituted slurry (2) in place of commercial grades of un-altered low LDA, which in this case was silica, and sodium silicate. Similarly, Mix D substituted slurry (3) in place of commercial grades of un-altered LDA, sodium silicate and silica filler. Both mixes were extruded using a single screw extruder. Setting and hardening times of the green material were measured using a modified soil penetrometer, the results of which are shown in Table 10. Extruded samples representing mixes C and D were wrapped in plastic and left to cure in an equilibrium room at about 20° C. room temperature and 50% relative humidity for 7 days. The samples (50 mm wide, 11 mm thick) were then tested in flexure at about 215 mm span in equilibrium condition. The mechanical properties for the mixes are compared in table 11.

TABLE 9
Mix compositions C and D (containing novel
slurries (2) and (3) respectively)

| | Mix C | Mix D |
|---|---|---|
| | (containing | (containing |
| | slurry 2) | slurry 3) |
| Dry Weight, g | 11000 | 11000 |
| Moisture, W/(W + S) | 43% | 43% |
| W/S | 75.44% | 75.44% |
| Mix Ingredients | % (Dry wt) | % (Dry wt) |
| Cellulose fiber | 9% | 9% |
| Cellulose Ether | 1.5% | 1.5% |
| Potassium Carbonate | 1.5% | 1.5% |
| Novel Slurry | 15% | 42% |
| Metakaolin | 6% | 6% |
| (1 um average size) | | |
| Cement | 40% | 40% |
| Silica | 27% | |

TABLE 10
Setting and hardening times for extruded
green pastes representing mixes D and E.

| | Setting Time | Hardening Time |
|---|---|---|
| | (minutes) | (minutes) |
| Mix C | 33 | 39 |
| Mix D | 86 | 97 |

TABLE 11
Seven-day Equilibrium flex properties for
extruded samples representing Mixes C & D

| | Modulus of | Modulus of | Ultimate | Oven-dry |
|---|---|---|---|---|
| | rupture | Elasticity | Strain/1000 | Density |
| | (MPa) | (GPa) | Micro mm/mm | gm/cm³ |
| Mix C | 7.97 | 2.46 | 7.09 | 1.08 |
| Mix D | 7.87 | 2.28 | 6.77 | 1.21 |

When compared with Mix A containing commercial additives, it can be seen that Mixes C and D exhibited comparable rapid setting and hardening times (Table 10 vs. Table 5), and comparable densities (Table 11 v. Table 6).

However, quite surprising and unexpected is the fact that mixtures incorporating the novel multi-function additives exhibited more than double the 7-day strength of Mix A, which contained the low density additive and water glass additives separately (table 11 v. table 6). This surprising result demonstrated the functionality of the novel multi-function additive as a hardening accelerator for air-cured fiber-reinforced cement-based composites. Without wishing to be bound by theory, it is believed that the additive used in the novel slurry experiences a greater degree of crosslinking, than commercial water glass used in previous cases. This greater degree of crosslinking enables it to react more readily with the reactive alumino-silicate and form inorganic polymers that serve to bond and provide strength to the air cured composite.

Example 4 illustrates the rapid hardening effect of the novel multi-function additive of another preferred embodiment.

Slurry (4) was prepared similarly to the other described slurries and consisted essentially of:

about 400 gm siliceous material, such as recycled soda lime glass having an average size of about 32 microns;

about 28 gm alkali compound, in the form of NaOH; and

about 40 gm mineral filler in the form of Elkem Microsilica Grade 940, which has a SiO₂ content >90%.

The slurry was milled for 60 minutes in a 1.5 gallon Szegvari laboratory batch attritor mill. The milled slurry was boiled for 3 hours in a 5-Gallon Agitated Batch Heating Tank. Slurry properties throughout the 2-stage process are shown in table 12.

TABLE 12
Properties of slurry (4) throughout the 2-stage process.

| | | After milling | |
|---|---|---|---|
| Slurry | Before | (size reduction/ | After boiling |
| Properties | milling | alkaline activation) | (digestion) |
| % Solids | 19.76 | 19.76 | 25.96 |
| Density (gm/ml) | 1.1 | 1.1 | 1.27 |
| Particle Size | | | |
| Distribution | | | |
| d(0.90), um | 97.06 | 6.186 | 9.352 |
| d(0.50), um | 32.556 | 3.31 | 5.428 |
| d(0.10), um | 6.495 | 1.837 | 3.08 |
| Viscosity (cps) | | 100 | 440 |

A lightweight fiber-reinforced cement-based mix (Mix E) incorporating slurry (4) was prepared with the ingredients as shown in Table 13 and processes known in the art. In comparison with Mix A, Mix E contains slurry (4) which was substituted in place of commercial grades of un-altered LDA density modifier and sodium silicate (water glass). This mix was extruded using a single screw extruder. Extruded samples (50 mm wide, 11 mm thick) were dried in an oven at 105° C. for 2 hrs. The dried samples were stored in an equilibrium room (20° C. room temperature, 50% relative humidity) then tested in flexure at a bout 215 mm span aged 4 hours and 7 days after extrusion. The 4-hour and 7-day mechanical properties for Mix E are shown in Table 14.

TABLE 13
Mix composition E (containing slurry (4))

| | Mix E |
|---|---|
| | (containing slurry 4) |
| Dry Weight, g | 11000 |
| Moisture, W/(W + S) | 43.0% |
| W/S | 75.44% |
| Mix Ingredients | % (Dry wt) |
| Cellulose fiber | 9% |
| Cellulose Ether | 1.5% |
| Potassium Carbonate | 1.5% |
| Zinc Stearate | 0.5% |
| Novel Slurry | 15% |
| Metakaolin (4.6 um average size) | 6% |
| Cement | 40% |
| Silica | 26.5% |

TABLE 14
4-hour and 7-day equilibrium flex properties for
dried extruded samples representing mix E.

| | Modulus of | Modulus of | Ultimate | Oven-dry |
|---|---|---|---|---|
| | rupture | Elasticity | Strain/1000 | Density |
| | (MPa) | (GPa) | Micro mm/mm | gm/cm³ |
| Age: 4 hrs | 5.09 | 1.54 | 5.99 | 1.1 |
| Age: 7 days | 8.67 | 2.02 | 7.63 | |

It can be seen that Mix E exhibited significant flexural strength (˜5 MPa) after 4 hours (2 hours drying at 105° C. and 2 hours conditioning at 20° C.). This result is quite surprising as the dried samples were deprived of the water necessary for cement hydration. It can also be seen that flexural strength continued to increase up to age 7 days indicating that the gain in strength could be caused by a non-hydraulic reaction such as polymerization of the alkali activated alumina silicate compounds present in the formulation. Example 5 illustrates the saturated to equilibrium strength ratio for fiber cement composites

Two lightweight fiber-reinforced cement-based mix compositions (Mixes F and G) were prepared in accordance to ingredients shown in table 15 and processes known in the art. Mix (F) contains slurry (1) along with 9% cellulose fibers and Mix (G) contains slurry (1) along with 2% cellulose fiber and 2% PVA fiber. Slurry (1) was prepared as described in example 1.

The mixes were extruded using a single screw extruder. Extruded samples representing mixes F and G were wrapped in plastic and left to cure in an equilibrium room (20° C. room temperature, 50% relative humidity) for 7 days. The samples (50 mm wide, 11 mm thick) were then tested in flexure at about 215 mm span in equilibrium and saturated conditions. The mechanical properties for mixes F and G (in saturated and equilibrium conditions) are compared in table 16.

TABLE 15
Mix compositions F and G (containing novel slurry (1)

| | | | Mix G (containing |
|---|---|---|---|
| | | Mix F | novel slurry (1), |
| | | (Containing novel | 2% Cellulose fiber, |
| | | slurry (1) and 9% | 2% PVA and 10% |
| | | Cellulose fiber) | commercial LDA) |
| Dry Weight, g | | 11000 | 11000 |
| Moisture, W/(W + S) | | 43% | 43% |
| W/S | | 75.44% | 75.44% |
| Mix Ingredients | | % (Dry wt) | % (Dry wt) |
| Cellulose fiber | | 9% | 2% |
| Cellulose Ether | | 1.5% | 1.5% |
| Potassium Carbonate | | 1.5% | 1.5% |
| Sodium Silicate | | | |
| (Type N - PQ Corp.) | | | |
| Commercial LDA | | | 10% |
| (Microcel E) | | | |
| Novel Additive | | | |
| Slurry Components | | | |
| (as per table 3) | | | |
| | Water glass | | |
| | Low Density Siliceous | 15% | 15% |
| | Particles | | |

| | | |
|---|---|---|
| Milled Metakaolin | 6% | 6% |
| (0.56 um average size) | | |
| Cement | 40% | 40% |
| Silica | 27% | 22% |
| PVA (6 mm × 40 um) | | 2% |
| RECS2 (%) | | |

TABLE 16
Seven-day saturated & equilibrium flex properties for samples representing mixes F and G.

| | | Modulus of | Sat/eq. | | Ultimate | Oven-dry |
|---|---|---|---|---|---|---|
| | Test | rupture | Strength | Modulus of | Strain/1000 | Density |
| | Condition | (MPa) | Ratio | Elasticity (GPa) | Micro mm/mm | gm/cm³ |
| Mix F | (Saturated) | 8.62 | 0.95 | 3.80 | 6.93 | 1.07 |
| | (Equilibrium) | 9.03 | | 1.75 | 9.77 | |
| Mix G | Saturated | 6 | 0.92 | 4.65 | 6.96 | 0.95 |
| | Equilibrium | 6.54 | | 1.16 | 12.79 | |

It can be seen that both mixes exhibited saturated/equilibrium strength ratio >0.9, indicating only about 10% degradation in strength due to wetting. This result is quite surprising, as strength degradation due to wetting in cement-based composites usually exceeds 50%.

Example 6 illustrates a spray-dried novel multi-function additive of another preferred embodiment.

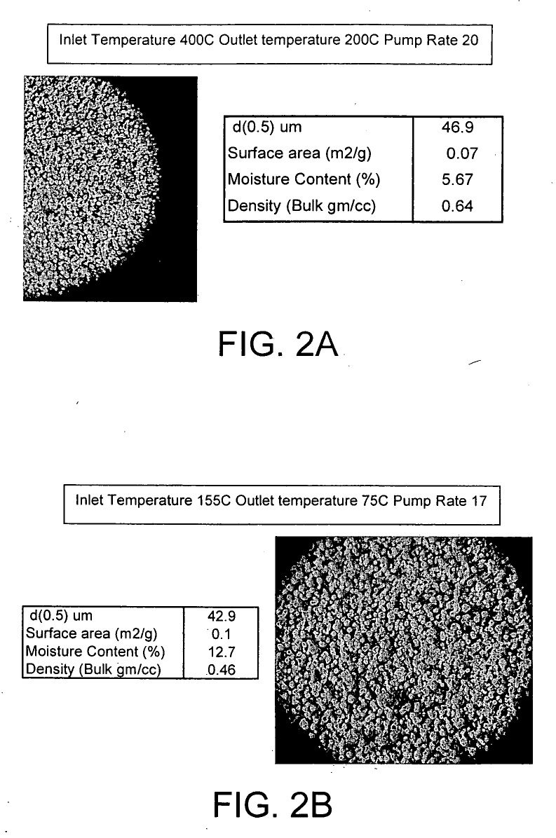

Four liters of slurry (1) were spray-dried forming fine spherical particles as shown in FIG. 2. In this case, the composite additive is converted from slurry form to solid form by spray drying.

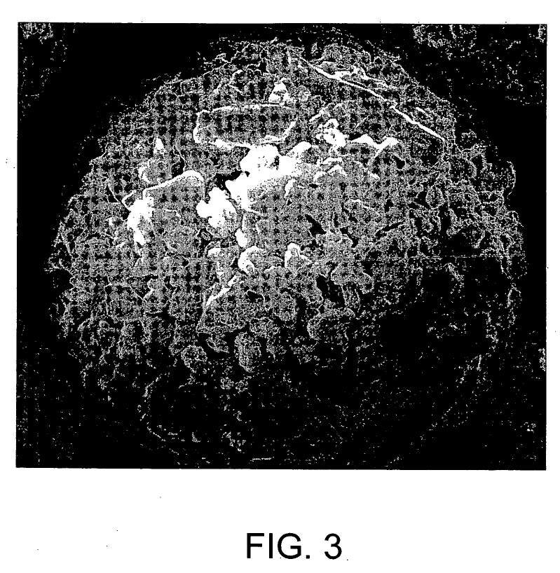

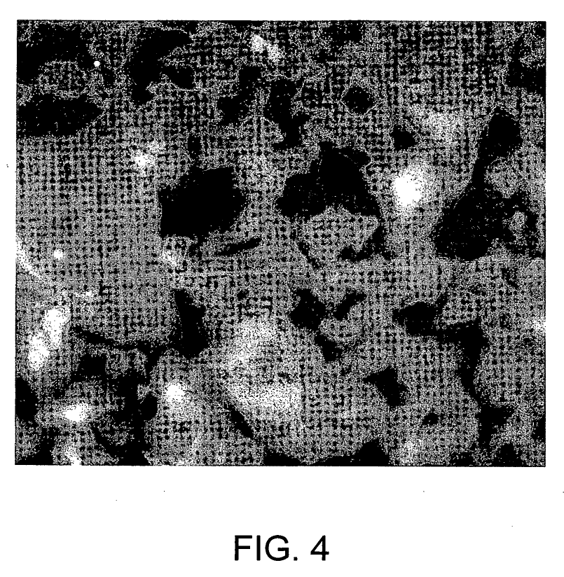

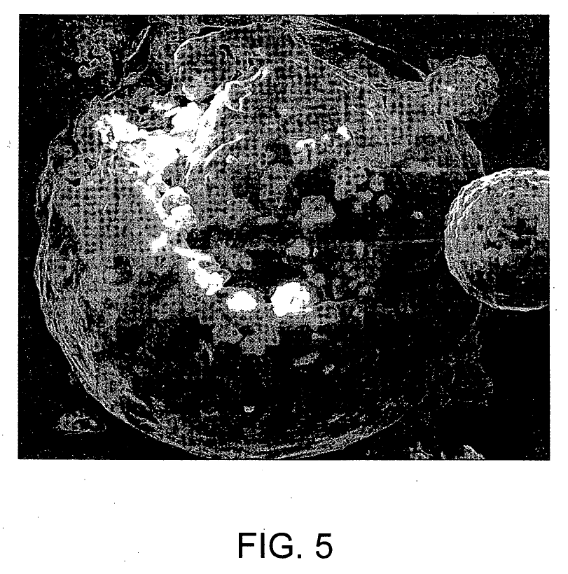

The slurry was sprayed through a Niro Production Minor Spray Dryer—rated at 10 to 20 kg moisture removal per hour, to achieve a particle size distribution of 40-50 microns. Properties of spray-dried powders A and B are shown in FIG. 2. The spray-dry processing conditions and properties of powders A & B are also shown in FIG. 2. FIG. 3 is a SEM image showing that the spray dried slurry formed porous spherical agglomerated particles. As shown in FIG. 3, the composite aggregate comprises micron size glass particles cemented together by a thin amorphous sodium silicate coating compound. As shown in FIG. 4, the modified siliceous particle has a morphologically altered (porous) exterior surface. As shown in FIG. 5, small aggregates can agglomerate together to form larger agglomerate encased in a thin coating of sodium silicate.

Advantageously, the preferred embodiments of the present invention provide a method of simultaneously producing a low cost, alkaline activation compound such as water glass (sodium silicate) and a high quality, low density additive for accelerating the hardening rate and modifying the density of a settable composite material with relatively simple and cost effective processes. According to the preferred embodiments, the multi-function additive can be formed from low cost waste byproducts utilizing simple and energy efficient processes. Examples of such processes are two-stage processes which include simultaneous milling of the starting materials in a mechano-chemical treatment such as an aqueous alkali hydroxide solution, followed by heat digestion either in an atmospheric or pressurized vessel. The two-stage process provides an energy efficient and low cost method for producing a composite additive comprises of water glass accelerator and ceramic density modifying material. In certain embodiments, novel cementitious compositions incorporating the composite additive and reactive aluminosilicate material can be produced. The novel multi-function additive can be utilized for producing rapid hardening low density cementitious compositions incorporating aluminosilicate material. For example, fiber cement products manufactured from this mixture have lower-cost, reduced curing times, and improved time to market.

As shown above, quite surprising and unexpected is the fact that compositions incorporating the novel multi-fiction additives exhibit more than double the strength as compared to compositions containing the commercially available un-altered low density additive and water glass additive. This surprising result demonstrates the functionality of the novel multi-function additive as a hardening accelerator for air-cured fiber-reinforced cement-based composites. It is also surprising that compositions incorporating the novel multi-function additive exhibit shorter setting and hardening times as compared to materials incorporating a commercially available, unaltered low density additive and water glass additive separately, which further demonstrates the potency and synergistic effect of the novel multi-function additive as a hardening accelerator.

Modified Low Density Siliceous Particles

In certain implementations, the modified low density siliceous particles of the preferred embodiments can be separated from the alkaline activation compound and incorporated in various building products. In one embodiment, the modified siliceous particles are filtered from the above-described slurry, dried, and packed together with other ingredients to form a low density brick using methods known in the art. Preferably, the modified low density siliceous particles are packed together, bound by a binder such as Portland cement, and formed into low density bricks and other products. The modified siliceous particles have a bulk density of less than or equal to 1,500 kg/m³.

Although the foregoing description of the preferred embodiments of the present invention has shown, described and pointed out the fundamental novel features of the invention, it will be understood that various omissions, substitutions, and changes in the form of the detail of the invention as illustrated as well as the uses thereof, may be made by those skilled in the art, without departing from the spirit of the invention. Particularly, it will be appreciated that the preferred embodiments of the invention may manifest itself in other formulations and compositions as appropriate for the end use of the article made thereby.

What is claimed is:

1. A multi-function additive composition for a settable composite material, comprising:
an alkaline activation compound; and
a plurality of modified siliceous particles, wherein each modified siliceous particle has a first region that is morphologically altered by a chemical, said first region comprising about 0.1%-90% of the volume of the particle.

2. The composition of claim 1, wherein the first region of the modified siliceous particle is gel-like.

3. The composition of claim 1, wherein the first region of the modified siliceous particle is porous.

4. The composition of claim 1, wherein the first region of the modified siliceous particle comprises an exterior surface of the particle.

5. The composition of claim 1, wherein the first region is chemically altered by said chemical.

6. The composition of claim 1, wherein the alkaline activation compound is selected from the group consisting of sodium silicate, potassium silicate and lithium silicate.

7. The composition of claim 1, wherein the weight percentage of the modified siliceous particles is at least equal to or greater than the weight percentage of the alkaline activation compound.

8. The composition of claim 1, wherein the composition is in a slurry form, said slurry comprising the alkaline activation compound which is dissolved in the liquid phase and the modified siliceous particles which are substantially solids mixed in the slurry.

9. The composition of claim 1, wherein the composition is in a paste form, said paste comprising the alkaline activation compound and the modified siliceous particles.

10. The composition of claim 1, wherein composition is in the form of a plurality of agglomerated particles comprising the modified siliceous particles bound together by the alkaline activation compound.

11. The composition of claim 1, wherein the composition enables said composite material to harden without being substantially subjected to a hydrothermal condition.

12. A cement formulation comprising the composition of claim 1.

13. A fiber cement building product comprising the composition of claim 1.

14. A polymeric matrix comprising the composition of claim 1.

15. A method of forming a multi-function additive for settable composite materials, comprising:
providing a siliceous material and an alkali compound;
reducing the particle size of the siliceous material; and
reacting the siliceous material with the alkali compound in a manner so as to form a mixture comprising alkali silicate and a plurality of modified low density siliceous particles, wherein each particle has at least a first portion that is morphologically altered by the alkali compound and at least a second portion that is not morphologically altered by the alkali compound.

16. The method of claim 15, wherein reducing the particle size of the siliceous material comprises milling the siliceous material in a wet process carried out in an aqueous slurry containing the alkali compound.

17. The method of claim 15, further comprising spray drying the slurry to form agglomerated particles comprised of said modified low density siliceous particles bound together by the alkali silicate.

18. The method of claim 15, wherein the alkali compound is selected from the group consisting of alkali metal hydroxide, alkaline earth metal hydroxide, weak-acid alkaline metal salts, and combinations thereof.

19. The method of claim 15, wherein the siliceous material and the alkali compound are reacted at a non hydrothermal condition to produce said alkali silicate and said modified low density siliceous particles.

20. The method of claim 15, wherein the siliceous material and the alkali compound are reacted at atmospheric pressure to produce said alkali silicate and said modified low density siliceous particles.

21. The method of claim 15, further comprising separating the modified low density siliceous particles from the alkali silicate.

22. The method of claim 15, wherein the step of reacting the siliceous material with the alkali compound comprises using a mechano-chemical process in which said siliceous material is substantially simultaneously milled and reacted with the alkali compound to form the alkali silicate and the modified low density siliceous particles.

23. A settable composite material, comprising:
a binder;
an aluminosilicate material;
a multi-fiction additive comprising alkali silicate and a plurality of modified low density siliceous particles, each of said low density siliceous particles having a first region that is morphologically altered by a chemical, each of said low density siliceous particles also having a second region that is not morphologically altered by said chemical; and
wherein the additive reacts with the aluminosilicate to enable the composite material to harden without being substantially subjected to a hydrothermal condition and wherein the modified low density siliceous particles lower the density of the composite material.

24. The composite material of claim 23, wherein the material is a cementitious composite material.

25. The composite material of claim 23, wherein the material is a fiber cement panel.

26. The composite material of claim 23, wherein the material is a cementitious brick.

27. The composite material of claim 23, wherein the binder comprises water glass.

28. The composite material of claim 23, wherein the multi-function additive increases the rate of hardening of the composite material by about 5%-100,000% as compared to an equivalent composite material without the multi-function additive.

29. The composite of material of claim 23, further comprising unmodified low density siliceous particles.

30. The composite material of claim 23, wherein the multi-function additive lowers the density of the composite material by about 0.1%-50% as compared to an equivalent composite material without the multi-function additive.

31. A method of accelerate setting and hardening for a settable composite material by adding a multi-fiction additive composition comprising an alkaline activation compound; and
a plurality of modified siliceous particles, wherein each modified siliceous particle has a first region that is morphologically altered by a chemical, said first region comprising about 0.1%-90% of the volume of the particle.

32. The method of claim 31, wherein the first region of the modified siliceous particle is gel-like.

33. The method of claim 31, wherein the first region of the modified siliceous particle is porous.

34. The method of claim 31, wherein the first region of the modified siliceous particle comprises an exterior surface of the particle.

35. The method of claim 31, wherein the alkaline activation compound is selected from the group consisting of sodium silicate, potassium silicate and lithium silicate.

36. The method of claim 31, wherein the weight percentage of the modified siliceous particles is at least equal to or greater than the weight percentage of the alkaline activation compound.

37. The method of claim 31, wherein the composition is in a slurry form, said slurry comprising the alkaline activation compound which is dissolved in the liquid phase and the modified siliceous particles which are substantially solids mixed in the slurry.

38. The method of claim 31, wherein the composition is in a paste form, said paste comprising the alkaline activation compound and the modified siliceous particles.

39. The method of claim 31, wherein composition is in the form of a plurality of agglomerated particles comprising the modified siliceous particles bound together by the alkaline activation compound.

40. The method of claim 31, wherein the composition enables said composite material to harden without the need of being subjected to a hydrothermal condition.
